(19) United States
(12) Patent Application Publication
(10) Pub. No.: US 2017/0009125 A1
(43) Pub. Date: Jan. 12, 2017

(54) CONTROLLING SOLIDS SUSPENSION IN SLURRY

(71) Applicant: Trican Well Service, Ltd., Calgary (CA)

(72) Inventors: Nisa Monica Shaffer, Conroe, TX (US); Jordan Lee Clark, The Woodlands, TX (US)

(73) Assignee: TRICAN WELL SERVICE, LTD., Calgary (CA)

(21) Appl. No.: 14/793,528

(22) Filed: Jul. 7, 2015

(51) Int. Cl. C09K 8/52; E21B 21/00

(52) U.S. Cl. CPC C09K 8/52; E21B 21/00

(57) ABSTRACT

A well fluid treatment is disclosed that utilizes ethoxylated alcohols with a hydrophilic lipophilic balance between 10 and 13 and/or alkyl benzene sulfonic acid and alkyl naphthalene sulfonic acids either neutralized or non-neutralized and salts thereof either singly or in combination to assist in suspending solids such as drilling mud and cement in fluids such as water.

### BACKGROUND

At various times during the life of a well it is desirable to treat the well. Such treatments include drilling, cementing, perforating, fracturing, gravel packing etc. These treatments generally involve pumping fluid with a number of agents typically solids, into the wellbore.

For instance when pumping a drilling mud the drilling mud may be a weighted or non-weighted water-based gel. When weighted, the weighting material may be a particulate such as barite.

One of the most important functions of a drilling fluid is to seal off the walls of the wellbore so that the fluid is not lost into highly permeable subterranean zones penetrated by the wellbore. This is accomplished by the deposit of a filter cake of solids from the drilling fluid, dehydrated drilling fluid and gelled drilling fluid over the surfaces of the wellbore whereby the solids bridge over the formation pores and do not permanently plug the pores.

During the drilling of a wellbore, the drilling fluid is continuously circulated down the interior of the drill pipe, through the drill bit and back to the surface in the annular area on the outside of the drill pipe. At various points the wellbore may need to be cased. In this event circulation of the drilling fluid ceases while the drill bit and drill pipe are removed from the well and casing is run into the well. With circulation stopped gelled and dehydrated drilling fluid and filter cake is deposited on the walls of the wellbore.

Once the casing has been run into the well typically cement is pumped through the interior of the casing, out the bottom of the casing, and back up the exterior sides of the casing. With cement in the area between the exterior of the casing and the wellbore the cement bonds the casing to the wellbore thereby sealing the annular area and preventing fluid communication axially along the exterior of the casing. Unfortunately the gelled and dehydrated drilling fluid and filter cake tend to provide a barrier between the cement and the desired bonding surface, either the casing or the wellbore, thereby preventing the cement from bonding the casing to the wellbore. Additionally, the drilling fluid is comparatively expensive therefore operators prefer to attempt to retrieve the maximum amount of drilling fluid from the wellbore in an effort to reduce costs. Therefore it is desirable to remove the gelled and dehydrated drilling fluid and filter cake prior to pumping cement into the well.

In an attempt to remove the remnants of the drilling fluid from the wellbore prior to cementing, a fluid flush or spacer may be pumped down through the casing and then back up through the annulus prior to cementing in order to remove drilling fluid and filter cake. Such spacers generally provide only minimal drilling fluid and filter cake removal.

### SUMMARY

In an effort to further enhance the removal of slurry from the wellbore, it is been found that by adding certain additives the solids in the slurry are kept in suspension for a sufficiently long period to aid in removing the solids from the well. The additives are combinations of one or more ethoxylated alcohols having a hydrophilic lipophilic balance between 10 and 13 where the ethoxylated alcohol may be tridecyl alcohol with 6EO ethoxylated alcohol (having 6 ethylene oxide (EO) groups) and/or C6-3EO ethoxylated alcohol, where C6-3EO has a six carbon backbone chained to three ethylene oxide groups. Additional additives that may be used are alkyl benzene sulfonic acid and alkyl naphthalene sulfonic acids either neutralized or non-neutralized and salts thereof in particular neutralized dodecyl benzene sulfonic acid may be used.

Additionally it was found that the same combinations, of tridecyl alcohol with 6EO ethoxylated alcohol (having 6 ethylene oxide groups), neutralized dodecyl benzene sulfonic acid, and C6-3EO ethoxylated alcohol, C6-3EO has a six carbon backbone chained to three ethylene oxide groups, tend to keep the solids in the cement in suspension aiding in the proper placement of the cement.

### BRIEF DESCRIPTION OF THE DRAWINGS

FIG. 1 depicts the result of the first test with fly ash, a polymer, water, and no suspension agent.

FIG. 2 depicts the result of the second test with fly ash, the polymer, water, and three suspending agents.

FIG. 3 depicts the result of the third test with fly ash, a second polymer, water, and no suspension agent.

FIG. 4 depicts the result of the fourth test with fly ash, the second polymer, water, and three suspension agents.

FIG. 5 depicts the result of the fifth test with fly ash, water, the second polymer, tridecyl alcohol with 6EO ethoxylated alcohol (having 6 ethylene oxide groups), and neutralized dodecyl benzene sulfonic acid.

FIG. 6 depicts the result of the sixth test with fly ash, the second polymer, tridecyl alcohol with 6EO ethoxylated alcohol (having 6 ethylene oxide groups), water, and C6-3EO ethoxylated alcohol.

FIG. 7 depicts the result of the seventh test with fly ash, the second polymer, neutralized dodecyl benzene sulfonic acid, water, and C6-3EO ethoxylated alcohol.

FIG. 8 depicts the result of the eighth test with fly ash, the second polymer, water, and tridecyl alcohol with 6EO ethoxylated alcohol (having 6 ethylene oxide groups).

FIG. 9 depicts the result of the ninth test with fly ash, the second polymer, water, and C6-3EO ethoxylated alcohol.

FIG. 10 depicts the result of the tenth test with fly ash, the second polymer, water, and neutralized dodecyl benzene sulfonic acid.

FIG. 11 depicts the result of the eleventh test with barite, the first polymer, the second polymer, and water.

FIG. 12 depicts the result of the twelfth test with barite, the first polymer, the second polymer, the three suspension agents, and water.

FIG. 13 depicts the results of the first cement slurry test where the slurry was cement and water.

FIG. 14 depicts the results of the second cement slurry test where the slurry was cement, the three suspension agents, and water.

FIG. 15 depicts the results of the second cement slurry test where the slurry was cement, C6-3EO ethoxylated alcohol, and water.

FIG. 16 depicts the results of the second cement slurry test where the slurry was cement, neutralized dodecyl benzene sulfonic acid, and water.

FIG. 17 depicts the results of the second cement slurry test where the slurry was cement, tridecyl alcohol with 6EO ethoxylated alcohol (having 6 ethylene oxide groups), and water.

FIG. 18 is a chart comparing the results of the free fluid test procedure.

### DETAILED DESCRIPTION

The description that follows includes exemplary apparatus, methods, techniques, or instruction sequences that embody techniques of the inventive subject matter. However, it is understood that the described embodiments may be practiced without these specific details.

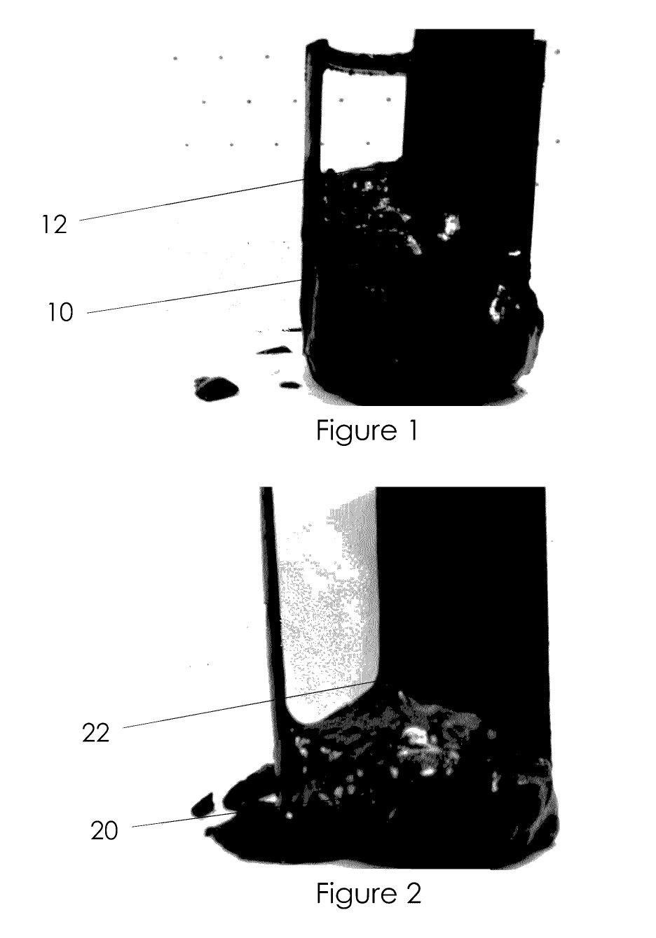

The test procedure used to gather the data in FIGS. 1-17 was to mix the slurry including the suspending agent. Pour the slurry into a cell having a modified paddle and then placing the cell into the consistometer. The cell is then heated to both bottom hole pressure, about 5600 psi, and bottom hole circulating temperature, which may vary from about 80° F. to as much as 300° F., while rotating the cell about the modified paddle at 150 RPM. The cell was then allowed to equilibrate for 10 minutes while rotating at 150 RPM. After 10 minutes of rotating at 150 RPM at bottom hole pressure and bottom hole circulating temperature the rotation rate of the cell was reduced to 25 RPM. The system was allowed to operate for an additional 30 minutes at 25 RPM, bottom hole pressure, and bottom hole circulating temperature. The cell pressure was then reduced from bottom hole pressure to atmospheric pressure and the temperature was reduced to approximately 190° F. While the cell was cooling the rotation rate of 25 RPM was maintained. Once the cell had reached approximately 190° F. or less the rotation of the cell was stopped. Density variance was then determined by using a 10 mL syringe, that's been zeroed on a balance. Three samples are then collected that will allow for the removal of air bubbles and a final volume of 10 mL from each of the top third, the middle third, and the bottom third. The mass of each sample is recorded and the weight versus the volume provides the density of each sample. The paddle will then be slowly pulled out of the slurry cup allowing for excess material to slide off without shaking the paddle. The cone height is then measured.

FIG. 1-12 depict a series of dynamic settling tests where a series of suspending agents were mixed into a slurry to determine the properties of the various fluids. The slurry is a polymer and a weighting agent.

FIG. 1 depicts the result of the first test wherein 308.51 pounds per barrel of fly ash was mixed with 1.5 pounds per barrel of welan gum, as a polymer, and 25 gallons per barrel of tap water. After running the resulting slurry 10 through the test procedure the slurry 10 gave a cone height 12 of 2.625 inches and a density variance of 3.68 pounds per gallon.

FIG. 2 depicts the result of the second test wherein 308.51 pounds per barrel of fly ash was mixed with 1.5 pounds per barrel of welan gum and 25 gallons per barrel of tap water. Additionally, a cumulative total of 1 gallon per barrel of all three components of the suspension enhancer were added to the slurry in the ratios of 27% tridecyl alcohol with 6EO ethoxylated alcohol (having 6 ethylene oxide groups), 27% neutralized dodecyl benzene sulfonic acid, and 56% C6-3EO ethoxylated alcohol. After running the resulting slurry 20 through the test procedure the slurry 20 gave a cone height 22 of 0.625 inches and a density variance of 0.36 pounds per gallon indicating that a significant portion of the fly ash was held suspended in the slurry.

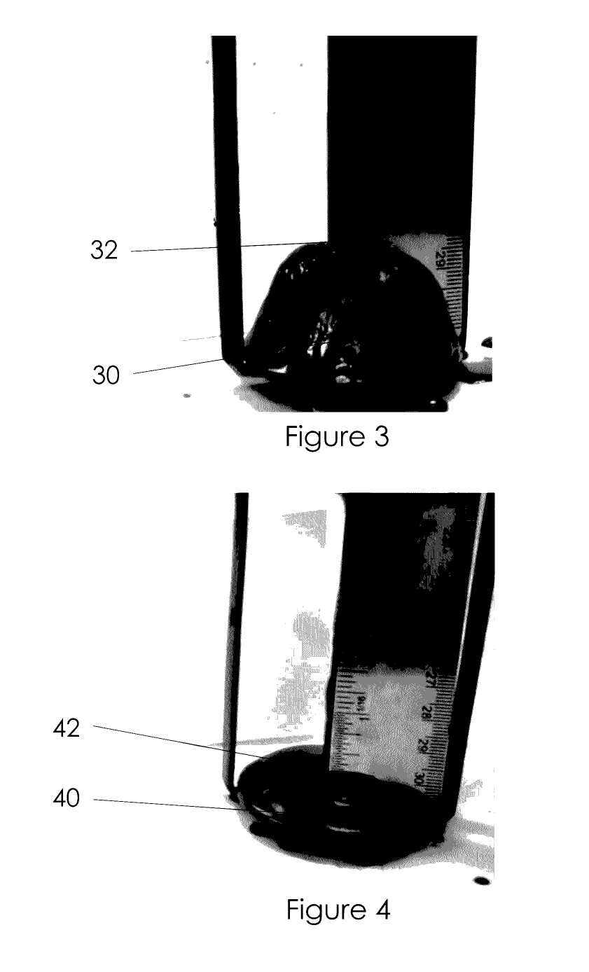

FIG. 3 depicts the result of the third test wherein 308.51 pounds per barrel of fly ash was mixed with 2.5 pounds per barrel of acrylamide tertiary butyl sulfonic acid or more specifically with 2-acrylamido-2-methyl propane sulfonic acid/N, N-dimethylacetamide copolymer and 25 gallons per barrel of tap water. After running the resulting slurry 30 through the test procedure the slurry 30 gave a cone height 32 of 0.875 inches and a density variance of 2.79 pounds per gallon.

FIG. 4 depicts the result of the fourth test wherein 308.51 pounds per barrel of fly ash was mixed with 2.5 pounds per barrel of 2-acrylamido-2-methyl propane sulfonic acid/N, N-dimethylacetamide copolymer and 25 gallons per barrel of tap water. Additionally, a cumulative total of 2 gallons per barrel of all three components of the suspension enhancer were added to the slurry in the ratios of 27% tridecyl alcohol with 6EO ethoxylated alcohol (having 6 ethylene oxide groups), 27% neutralized dodecyl benzene sulfonic acid, and 56% C6-3EO ethoxylated alcohol. The resulting slurry 40 gave a reduced cone height 42 of 0.25 inches and a density variance of 2.08 pounds per gallon indicating that a significant portion of the fly ash was held suspended in the slurry.

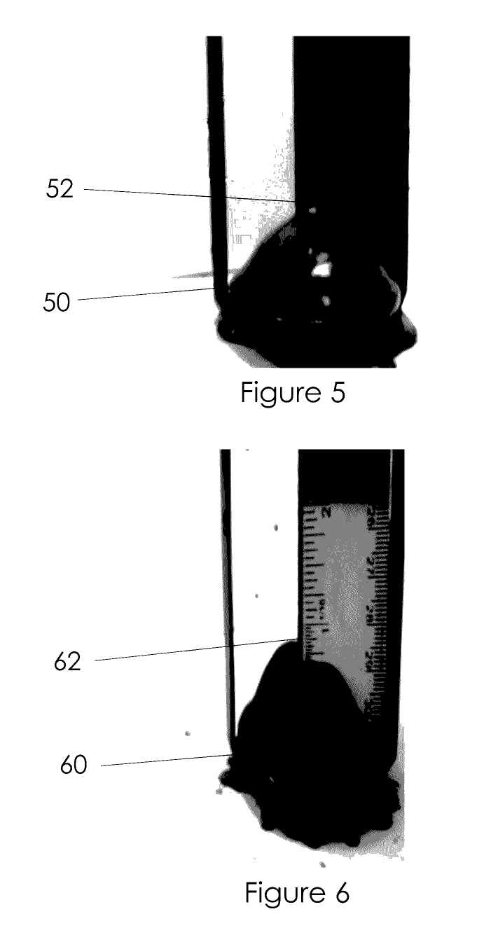

FIG. 5 depicts the result of the fifth test wherein 308.51 pounds per barrel of fly ash was mixed with 2.5 pounds per barrel of 2-acrylamido-2-methyl propane sulfonic acid/N, N-dimethylacetamide copolymer and 25 gallons per barrel of tap water. Additionally, two components of the suspension enhancer were added to the slurry 50. The two components were added in the amounts of 0.5 gallons per barrel of tridecyl alcohol with 6EO ethoxylated alcohol (having 6 ethylene oxide groups) and 0.5 gallons per barrel of neutralized dodecyl benzene sulfonic acid. The resulting slurry 50 gave a cone height 52 of 0.5 inches and a density variance of 0.63 pounds per gallon.

FIG. 6 depicts the result of the sixth test wherein 308.51 pounds per barrel of fly ash was mixed with 2.5 pounds per barrel of 2-acrylamido-2-methyl propane sulfonic acid/N, N-dimethylacetamide copolymer and 25 gallons per barrel of tap water. Additionally, two components of the suspension enhancer were added to the slurry 60. The two components were added in the amounts of 0.5 gallons per barrel of tridecyl alcohol with 6EO ethoxylated alcohol (having 6 ethylene oxide groups) and 0.5 barrels per gallon of C6-3EO ethoxylated alcohol. The resulting slurry 60 gave a cone height 62 of 0.625 inches and a density variance of 2.29 pounds per gallon.

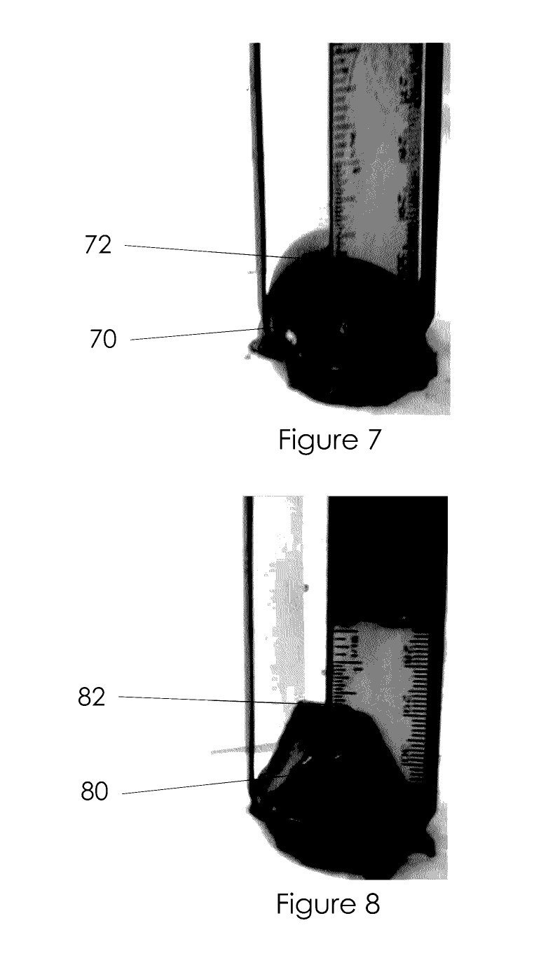

FIG. 7 depicts the result of the seventh test wherein 308.51 pounds per barrel of fly ash was mixed with 2.5 pounds per barrel of 2-acrylamido-2-methyl propane sulfonic acid/N, N-dimethylacetamide copolymer and 25 gallons per barrel of tap water. Additionally, two components of the suspension enhancer were added to the slurry 70. The two components were added in the amounts of 0.5 gallons per barrel of neutralized dodecyl benzene sulfonic acid and 0.5 barrels per gallon of C6-3EO ethoxylated alcohol. The resulting slurry 70 gave a cone height 72 of 0.25 inches and a density variance of 0.5 pounds per gallon.

FIG. 8 depicts the result of the eighth test wherein 308.51 pounds per barrel of fly ash was mixed with 2.5 pounds per barrel of 2-acrylamido-2-methyl propane sulfonic acid/N, N-dimethylacetamide copolymer and 25 gallons per barrel of tap water. Additionally, a single component of the suspension enhancer was added to the slurry 80. The single component of the slurry enhancer was added in an amount of 1.0 gallon per barrel of tridecyl alcohol with 6EO ethoxylated alcohol (having 6 ethylene oxide groups). The resulting slurry 80 gave a cone height 82 of 0.625 inches and a density variance of 1.27 pounds per gallon.

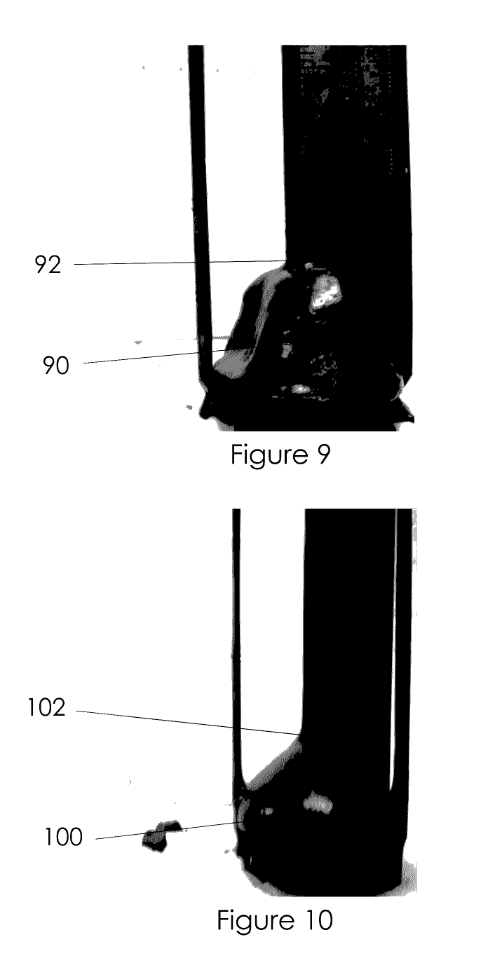

FIG. 9 depicts the result of the ninth test wherein 308.51 pounds per barrel of fly ash was mixed with 2.5 pounds per barrel of 2-acrylamido-2-methyl propane sulfonic acid/N, N-dimethylacetamide copolymer and 25 gallons per barrel of tap water. Additionally, a single component of the suspension enhancer was added to the slurry 90. The single component of the slurry enhancer was added in an amount of 1.0 gallon per barrel of C6-3EO ethoxylated alcohol. The resulting slurry 90 gave a cone height 92 of 0.875 inches and a density variance of 2.14 pounds per gallon.

FIG. 10 depicts the result of the tenth test wherein 308.51 pounds per barrel of fly ash was mixed with 2.5 pounds per barrel of 2-acrylamido-2-methyl propane sulfonic acid/N, N-dimethylacetamide copolymer and 25 gallons per barrel of tap water. Additionally, a single component of the suspension enhancer was added to the slurry 100. The single component of the slurry enhancer was added in an amount of 1.0 gallon per barrel of neutralized dodecyl benzene sulfonic acid. The resulting slurry 100 gave a cone height 102 of 0.375 inches and a density variance of 3.28 pounds per gallon.

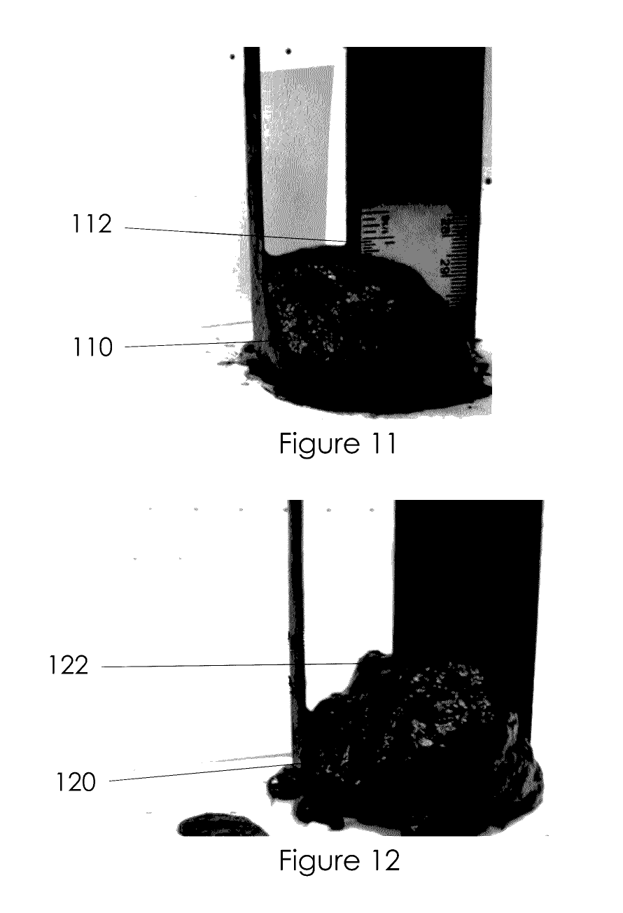

FIG. 11 depicts the result of the eleventh test wherein 308.51 pounds per barrel of barite was mixed with 2.5 pounds per barrel of 2-acrylamido-2-methyl propane sulfonic acid/N, N-dimethylacetamide copolymer, 2.5 pounds per barrel of welan gum, and 25 gallons per barrel of tap water. After running the resulting slurry 110 through the test procedure the slurry 110 gave a cone height 112 of 0.875 inches and a density variance of 7.38 pounds per gallon.

FIG. 12 depicts the result of the twelfth test wherein 308.51 pounds per barrel of barite was mixed with 2.5 pounds per barrel of 2-acrylamido-2-methyl propane sulfonic acid/N, N-dimethylacetamide copolymer, 2.5 pounds per barrel of welan gum, and 25 gallons per barrel of tap water. Additionally, a cumulative total of 2 gallons per barrel of all three components of the suspension enhancer were added to the slurry 120 in the ratios of 27% tridecyl alcohol with 6EO ethoxylated alcohol (having 6 ethylene oxide groups), 27% neutralized dodecyl benzene sulfonic acid, and 56% C6-3EO ethoxylated alcohol. The resulting slurry 120 gave a reduced cone height 122 of 0.875 inches and a density variance of 2.39 pounds per gallon.

FIG. 13-17 depict a series of dynamic settling tests, as described above, where a series of suspending agents were mixed into slurry to determine the properties of the various fluids. Additionally a free fluid test was conducted with the various cement slurries. Free fluid test conducted by pouring a portion of the mixed cement slurry into a 250 mL graduated cylinder and allowing the slurry to rest for two hours. Any fluid that separates out is removed from the top and its volume is recorded so that a percentage of free fluid may then be calculated.

FIG. 13 depicts the result of the first cement slurry test wherein 94 pounds per sack of cement was mixed with water and no suspending agent. The water gave a total of 5.27 gallons per sack of liquid. After running the resulting slurry 130 through the dynamic settling test procedure the slurry 130 gave a cone height 132 of 0.625 inches, a density variance of 1.23 pounds per gallon, and free fluid test result of 4.8%.

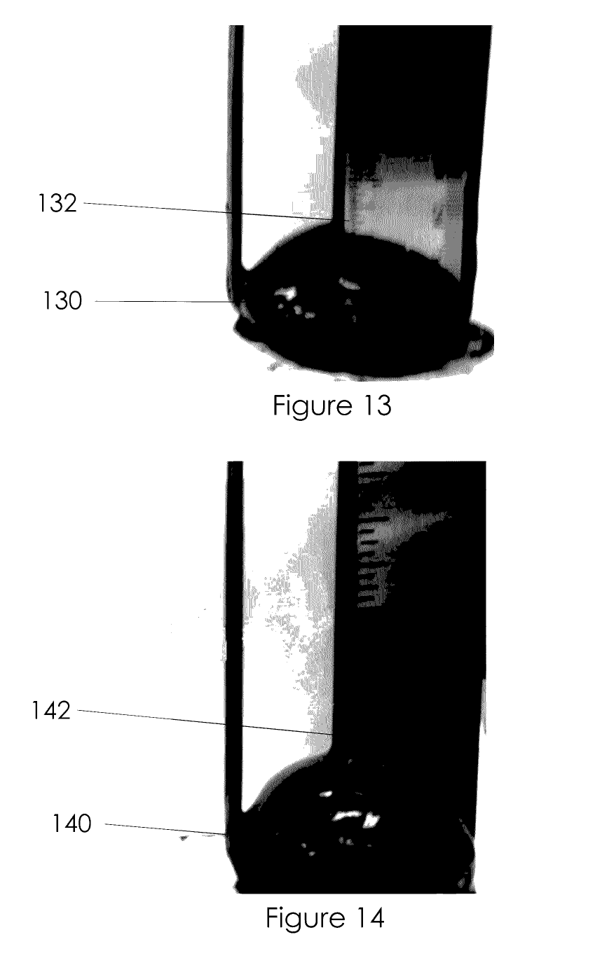

FIG. 14 depicts the result of the second cement slurry test wherein 94 pounds per sack of cement was mixed with water and a cumulative total of 0.21 gallons per sack of all three components of the suspension enhancer in the ratios of 27% tridecyl alcohol with 6EO ethoxylated alcohol (having 6 ethylene oxide groups), 27% neutralized dodecyl benzene sulfonic acid, and 56% C6-3EO ethoxylated alcohol. The 5.06 gallons per sack of water and the cumulative total of 0.21 gallons per sack of the three components gave a total of 5.27 gallons per sack of liquid. After running the resulting slurry 140 through the dynamic settling test procedure the slurry 140 gave a cone height 142 of 0.41 inches, a density variance of 1.0 pounds per gallon, and free fluid test result of 1.4%.

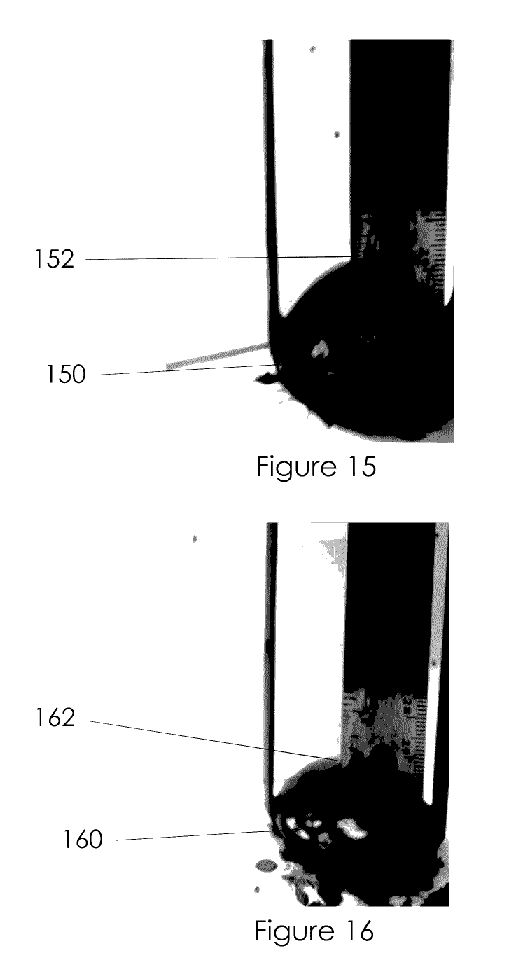

FIG. 15 depicts the result of the third cement slurry test wherein 94 pounds per sack of cement was mixed with water and 0.21 gallons per sack of C6-3EO ethoxylated alcohol. The 5.06 gallons per sack of water and the 0.21 gallons per sack of C6-3EO ethoxylated alcohol gave a total of 5.27 gallons per sack of liquid. After running the resulting slurry 150 through the dynamic settling test procedure the slurry 150 gave a cone height 152 of 0.5 inches, a density variance of 0.78 pounds per gallon, and free fluid test result of 6.4%.

FIG. 16 depicts the result of the fourth cement slurry test wherein 94 pounds per sack of cement was mixed with water and 0.21 gallons per sack of neutralized dodecyl benzene sulfonic acid. The 5.06 gallons per sack of water and the 0.21 gallons per sack of neutralized dodecyl benzene sulfonic acid gave a total of 5.27 gallons per sack of liquid. After running the resulting slurry 160 through the dynamic settling test procedure the slurry 160 gave a cone height 162 of 0.38 inches, a density variance of 0.84 pounds per gallon, and free fluid test result of 4.9%.

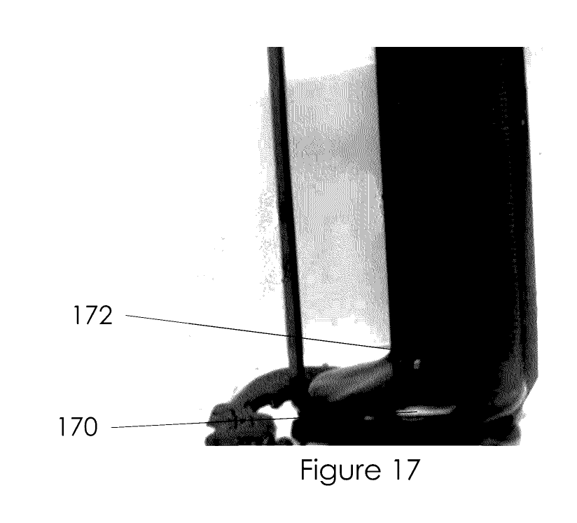

FIG. 17 depicts the result of the fifth cement slurry test wherein 94 pounds per sack of cement was mixed with water and 0.21 gallons per sack of tridecyl alcohol with 6EO ethoxylated alcohol (having 6 ethylene oxide groups). The 5.06 gallons per sack of water and the 0.21 gallons per sack of tridecyl alcohol with 6EO ethoxylated alcohol (having 6 ethylene oxide groups) gave a total of 5.27 gallons per sack of liquid. After running the resulting slurry 170 through the dynamic settling test procedure the slurry 170 gave a cone height 172 of 0.13 inches, a density variance of 0.11 pounds per gallon, and free fluid test result of 0.0%.

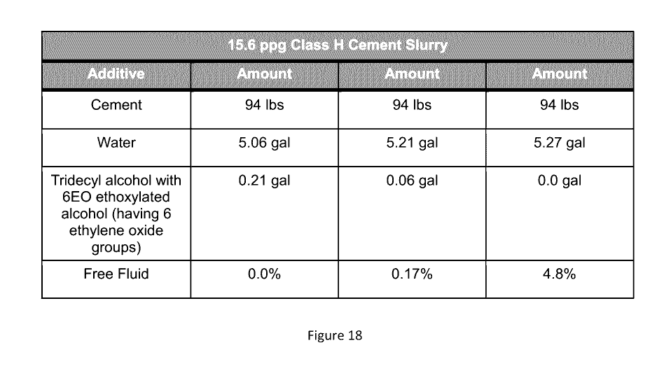

FIG. 18 is a chart comparing the results of the free fluid test procedure when various amounts of tridecyl alcohol with 6EO ethoxylated alcohol (having 6 ethylene oxide groups) are used with a single sack of cement, about 94 pounds, and 5.06-5.27 gallons of water. In the test comparison 0.0 gallons of tridecyl alcohol with 6EO ethoxylated alcohol (having 6 ethylene oxide groups) is used resulting in a free fluid ratio of about 4.8%. Then, 0.06 gallons of tridecyl alcohol with 6EO ethoxylated alcohol (having 6 ethylene oxide groups) is used resulting in a free fluid ratio of about 0.17%. Finally, 0.21 gallons of tridecyl alcohol with 6E0 ethoxylated alcohol (having 6 ethylene oxide groups) is used resulting in a free fluid ratio of about 0.0%.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A well fluid suspension enhancer comprising:
a solid powder,
a water,
and at least one suspending agent,
wherein the suspending agent is one or more ethoxylated alcohols having a hydrophilic lipophilic balance between 10 and 13, alkyl benzene sulfonic acid, or alkyl naphthalene sulfonic acids.

2. The system of claim 1 wherein, the solid is fly ash.

3. The system of claim 1 wherein, the solid is barite.

4. The system of claim 1 wherein, the solid is cement.

5. The system of claim 1 wherein, the solid is hematite.

6. The system of claim 1 wherein, the solid is hausmanite.

7. The system of claim 1 wherein, the suspending agent is tridecyl alcohol with 6EO ethoxylated alcohol, dodecyl benzene sulfonic acid, or C6-3EO ethoxylated alcohol.

8. The system of claim 7 wherein, the dodecyl benzene sulfonic acid is neutralized.

9. The system of claim 7 wherein, the dodecyl benzene sulfonic acid is non-neutralized.

10. The system of claim 1 wherein, the cumulative total of suspending agent is added in an amount between 0.0004 gallons per pound of slurry and 0.008 gallons per pound of slurry.

11. The system of claim 1 wherein, the cumulative total of suspending agent is added in an amount between 0.0015 gallons per pound of slurry and 0.004 gallons per pound of slurry.

12. The system of claim 1 wherein, the viscosifier is a biopolymer.

13. The system of claim 12 wherein, the polymer is welan gum.

14. The system of claim 1 wherein, the viscosifier is a synthetic polymer.

15. The system of claim 14 wherein, the synthetic polymer is acrylamide tertiary butyl sulfonic acid.

16. Method of enhancing the suspension of solids in a well fluid comprising:
mixing a solid powder in water,
adding at least one suspension agent,
wherein the suspending agent is one or more ethoxylated alcohols having a hydrophilic lipophilic balance between 10 and 13, alkyl benzene sulfonic acid, or alkyl naphthalene sulfonic acids, and
pumping the solid powder, water, and at least one suspension agent into a well.

17. The method of claim 16 wherein, the solid is fly ash.

18. The method of claim 16 wherein, the solid is barite.

19. The method of claim 16 wherein, the solid is cement.

20. The method of claim 16 wherein, the solid is hematite.

21. The method of claim 16 wherein, the solid is hausmanite.

22. The method of claim 16 wherein, the suspending agent is tridecyl alcohol with 6EO ethoxylated alcohol, dodecyl benzene sulfonic acid, or C6-3EO ethoxylated alcohol.

23. The method of claim 16 wherein, the dodecyl benzene sulfonic acid is neutralized.

24. The method of claim 16 wherein, the dodecyl benzene sulfonic acid is non-neutralized

25. The method of claim 16 wherein, the cumulative total of suspending agent is added in an amount between 0.0004 gallons per pound of slurry and 0.008 gallons per pound of slurry.

26. The method of claim 16 wherein, the cumulative total of suspending agent is added in an amount between 0.0015 gallons per pound of slurry and 0.004 gallons per pound of slurry.

27. The method of claim 16 wherein, the viscosifier is a biopolymer.

28. The method of claim 27 wherein, the polymer is welan gum.

29. The method of claim 16 wherein, the viscosifier is a synthetic polymer

30. The method of claim 29 wherein, the synthetic polymer is acrylamide tertiary butyl sulfonic acid.
